(19) United States
(12) Patent Application Publication
(10) Pub. No.: US 2026/0131302 A1
(43) Pub. Date: May 14, 2026

(54) FLUID REACTOR

(71) Applicant: THE UNIVERSITY OF ADELAIDE, Adelaide (AU)

(72) Inventors: Graham Jerold NATHAN, Adelaide (AU); Mehdi JAFARIAN, Adelaide (AU)

(21) Appl. No.: 19/121,794

(22) PCT Filed: Oct. 18, 2023
(86) PCT No.: PCT/AU2023/051036

§ 371 Date: Apr. 16, 2025

(30) Foreign Application Priority Data
Oct. 18, 2022 (AU) 2022903068

(51) Int. Cl. B01J 19/18; C01B 32/05

(52) U.S. Cl. CPC B01J 19/1837; C01B 32/05; B01J 2219/00033; B01J 2219/0004; B01J 2219/1943; B01J 2219/332

(57) ABSTRACT

There is a need to provide a system that can meet the thermal requirements of high-temperature reactions, particularly those involving molten substances. There is provided a new fluid reactor, and a method for using the reactor. The reactor for reacting a fluid with a gas comprises two first vessels in direct contact with two second vessels, with apertures arranged in a series to direct fluid in the first vessels to flow towards and through the aperture of each first vessel and into a connected second vessel by gas entering each first vessel through a gas inlet, and with apertures of the second vessels that allow the fluid flowing from each first vessel through each second vessel to flow into a first vessel connected to the second vessel.

### PRIORITY DOCUMENT

The present application claims priority from Australian Provisional Patent Application No. 2022903068 titled “MULTI-VESSEL FLUID REACTOR” and filed on 18 Oct. 2022, the content of which is hereby incorporated by reference in its entirety.

### TECHNICAL FIELD

The present disclosure relates to a new fluid reactor, and a method for using the reactor. In a particular form, the present disclosure relates to a fluid reactor that is suitable for reacting a fluid with a gas, and which facilitates the distribution of heat through the fluid.

### BACKGROUND

Molten substances (such as pure metals, salts and alloys) are used as catalysts in many industrial processes. One problem with using molten substances as catalysts for an endothermic reaction is that of how to provide the heat to drive the reaction without needing to heat the media through the reactor walls. One challenge to heating the media through a wall occurs with the use of reactive molten media, such as molten metals, since any covering of the wall with a protective lining to protect the reactor wall also inhibits heat transfer, since these coatings are typically thermal insulators. Another challenge to heating the media through the wall occurs where the reaction generates fine particles, such as occurs with the methane pyrolysis reaction, since heating through the wall will preferentially cause the deposition of the particles onto the reactor wall, which will inhibit the reaction process and generate maintenance challenges. There is also a need to minimise heat losses through the walls in a circulating fluid reactor by reducing surface area with the external environment. This is necessary to ensure that the fluid in all locations within the reactor remains in the molten state to be effective, particularly when they are used to catalyse endothermic reactions involving gases. Therefore, the systems for carrying out reactions involving these catalysts need to be able to provide sufficiently high temperatures for the catalysts to remain in the molten state at all locations within the reactor. This is particularly the case for liquid metals, which solidify if the temperature becomes too low in any location, resulting in not only inefficient reaction and low yield of product, but also blockage of the system.

WO2018/132875 describes an apparatus that can be used as a reactor system for fluids and gases, and that utilises concentrated solar radiation as the heat source. An alternative reactor system for fluids and gases is described in WO2019/226416. However, neither of these documents provides a reactor system that adequately deals with heat loss.

There is thus a need to provide a system that can meet the thermal requirements of high-temperature reactions, particularly those involving molten substances. Alternatively, or in addition, there is a need for a method to separate particles that are produced in a reaction within a molten metal reactor, for the case where the particles are less dense than the molten media. This is the case that occurs in methane pyrolysis, where the carbon product typically floats to the top of the reactor. To allow the reactor to operate continuously, it is necessary to provide a method for continuous removal of the floating carbon from the top of the reactor.

### SUMMARY

According to a first aspect, there is provided a reactor for reacting a fluid with a gas, the reactor comprising:
two first vessels, each first vessel comprising a gas inlet; and
two second vessels,
wherein one of the second vessels is situated between the two first vessels such that the second vessel is in direct contact with each first vessel, and at least one of the first vessels is situated between the two second vessels such that the first vessel is in direct contact with each second vessel, wherein the direct contact facilitates heat exchange between the vessels, and
wherein each of the first vessels and each of the second vessels comprise an aperture, wherein:
the aperture of each first vessel connects each first vessel with at least one second vessel,
the aperture of each second vessel is situated at the bottom of each second vessel,
the apertures of the first vessels are situated above the apertures of the second vessels, and
the apertures are arranged in a series,
such that fluid in the first vessels is directed to flow towards and through the aperture of each first vessel and into a connected second vessel by gas entering each first vessel through the gas inlet, and the apertures of the second vessels allow the fluid flowing from each first vessel and through each second vessel to flow into a first vessel connected to the second vessel.

At least one of the apertures of the first vessels may be situated at the top of the reactor. At least one of the apertures of the first vessels may be a gap between a sidewall of one of the first vessels and the top of the reactor. At least one of the apertures of the first vessels may be a hole in a sidewall of one of the first vessels. At least one of the apertures of the second vessels may be situated at the bottom of the reactor. At least one of the apertures of the second vessels may be a gap between a sidewall of one of the second vessels and the bottom of the reactor. At least one of the apertures of the second vessels may be a hole in a sidewall of one of the second vessels.

In at least one of the first vessels, the gas inlet may be situated at the bottom of the vessel.

In one form, each of the first vessels is situated between, is in direct contact with, and is connected to two second vessels, such that fluid flowing through the reactor moves in a circular motion through the vessels, when viewed from above or below.

The reactor may further comprise at least one gas outlet. The gas outlet may be situated in or at the top of the reactor.

At least one of the first vessels may further comprise at least one product outlet. The product outlet may be situated at the top of the first vessel. A weir may be configured to retain fluid in the reactor and allow product to enter the product outlet of the first vessel. At least one of the second vessels may further comprise a product outlet. The product outlet may be situated at the top of the second vessel. A weir may be configured to retain fluid in the reactor and allow product to enter the product outlet of the second vessel.

At least one of the first vessels may further comprise a feed stream inlet. The feed stream inlet may be situated at the bottom of the vessel.

There is also provided a method of reacting a fluid with a gas to produce a solid product, the method comprising:
providing a reactor as described herein, wherein the reactor comprises, in a first vessel (vessel A), a fluid;
introducing into vessel A a reaction gas for mixing and reaction with the fluid, such that the gas passes through the fluid and directs the fluid and gas mixture to flow towards and through the aperture of vessel A and into a connected second vessel (vessel B), wherein the aperture of vessel B allows the fluid flowing through vessel B from vessel A to flow into a further first vessel (vessel C);
introducing into vessel C a second gas, the second gas directing the fluid and gas mixture to flow towards and through the aperture of vessel C and into a connected second vessel (vessel D), wherein the aperture of vessel D allows the fluid flowing through vessel D from vessel C to flow back into vessel A;
collecting a solid product from the product outlet.

The fluid may be selected from a molten metal, a molten salt, a molten alloy, or a combination thereof. The fluid may be a molten catalyst.

The reaction gas may be natural gas. The reaction gas may comprise methane. The reaction gas may consist of methane. The solid product may be carbon.

The second gas may be an inert gas. The inert gas may be heated.

### BRIEF DESCRIPTION OF DRAWINGS

Some embodiments of the present disclosure will be discussed with reference to the accompanying drawings wherein:

FIG. 1 is a schematic representation of a top view of an embodiment of the reactor of the present invention comprising four vessels in direct contact to form a cylindrical reactor.

FIG. 2 is a schematic representation of a side view of an embodiment of the reactor of the present invention comprising four vessels in direct contact and connected using weir apertures.

FIG. 3 is a schematic representation of a side view of an embodiment of the reactor of the present invention of FIG. 2 that is rotated approximately 90 degrees.

FIG. 4 is a schematic representation of an isometric view of an embodiment of the reactor of the present invention comprising four vessels in direct contact and connected using weir apertures. The circulating molten fluid within the reactor has been shown with solid arrows in the foreground and dashed arrows in the background.

FIG. 5 is a schematic representation of an isometric view of an embodiment of the reactor of the present invention of FIG. 4 that is rotated approximately 90 degrees. The circulating molten fluid within the reactor has been omitted for clarity.

FIG. 6 is a schematic representation of an isometric view of an embodiment of the reactor of the present invention comprising four vessels in direct contact and connected using gate apertures. The circulating molten fluid within the reactor has been omitted for clarity.

FIG. 7 is a schematic representation of a top view of an embodiment of the reactor of the present invention comprising four vessels in direct contact to form an approximately square prism reactor.

FIG. 8 is a schematic representation of a side view of an embodiment of the reactor of the present invention comprising four vessels in direct contact and connected using weir apertures. An alternative embodiment of the outlet is shown.

FIG. 9 is a schematic representation of a side view of an embodiment of the reactor of the present invention of FIG. 2 that is rotated approximately 90 degrees. An alternative embodiment of the outlet is shown with a product overflow weir.

FIG. 10 is a schematic representation of a side view of an embodiment of the reactor of the present invention of FIG. 2 that is rotated approximately 90 degrees.

FIG. 11 is a schematic representation of a side view of an embodiment of the reactor of the present invention of FIG. 2 that is rotated approximately 90 degrees. An alternative embodiment of the outlet is shown with a product overflow weir.

FIG. 12 is a schematic representation of an isometric view of an embodiment of the reactor of the present invention comprising four vessels in direct contact and connected using gate apertures. The circulating molten fluid within the reactor has been omitted for clarity. An embodiment of the outlet is shown with the outlet in a second vessel.

FIG. 13 is a schematic representation of an isometric view of an embodiment of the reactor of the present invention comprising four vessels in direct contact and connected using gate apertures. The circulating molten fluid within the reactor has been omitted for clarity. An embodiment of the outlet is shown with the outlet in a first vessel.

FIG. 14 is a schematic representation of cross section view of an embodiment of the reactor of the present invention comprising four vessels in direct contact and connected using weir apertures. An embodiment of the movement of the circulating molten fluid within the reactor and the product is shown.

In the following description, like reference characters designate like or corresponding parts throughout the figures.

### DESCRIPTION OF EMBODIMENTS

The present inventor has developed a new reactor, in which the constituent vessels are in direct contact with each other, thereby allowing more effective management of the heat in the reactor. The arrangement mitigates heat loss from the fluid, thereby allowing molten substances to remain in the fluid state for a longer period, resulting in more productive reactions. By also maintaining the substances in a molten state more effectively, the likelihood of blockages is reduced.

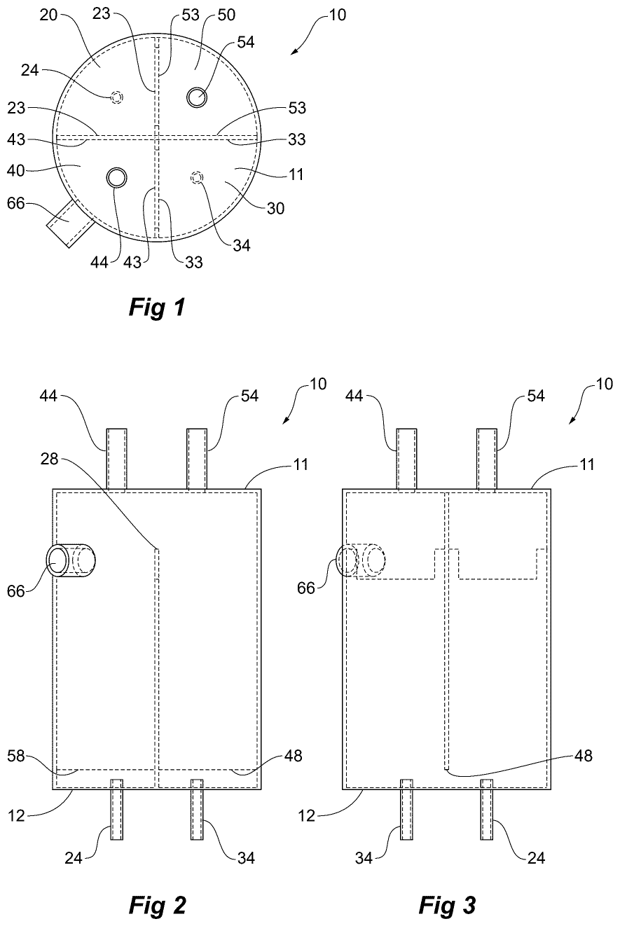

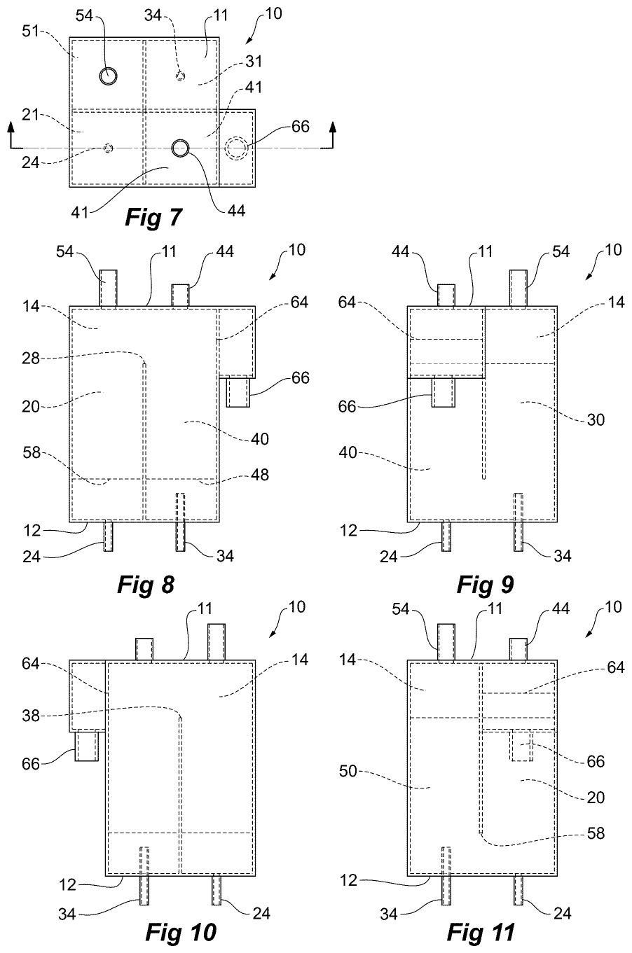

Referring now to FIGS. 1-14, there is shown a reactor 10 comprising four vessels. In the embodiments shown in FIGS. 1-14, the four vessels 20, 30, 40, 50 are formed as a result of dividing the cylindrical reactor 10 into quarters using vertical partitions. However, a person skilled in the art will be aware that the reactor 10 may be formed in several different ways using four (or more) vessels. For example, four (or more) otherwise separate vessels could be brought together such that they are in direct contact with each other. All such alternatives are intended to be within the scope of the present invention.

By “direct contact” it is meant that each of the vessels 20, 30, 40, 50 is physically touching at least one other vessel, such that heat can be readily exchanged between the vessels 20, 30, 40, 50 that are in direct contact with each other through the point(s) of direct contact. Typically, this direct contact will be achieved by the sidewalls 23, 33, 43, 53 of the vessels 20, 30, 40, 50 touching each other, or, in the case of embodiments such as those shown in FIGS. 1-14, may be achieved by the vessels 20, 30, 40, 50 sharing one or more sidewalls 23, 33, 43, 53. Therefore, in the reactor 10 of the present invention, which comprises two first vessels 20, 30 and two second vessels 40, 50, one of the second vessels 40, 50 is situated between the two first vessels 20, 30 such that the second vessel 40, 50 is in direct contact with each first vessel 20, 30, and at least one of the first vessels 20, 30 is situated between the two second vessels 40, 50 such that the first vessel 20, 30 is in direct contact with each second vessel 40, 50, wherein the direct contact facilitates heat exchange between the vessels 20, 30, 40, 50. In one form of the reactor 10 of the present invention, each of the first vessels 20, 30 is situated between, is in direct contact with, and is connected to two second vessels 40, 50, such that fluid 60 flowing through the reactor 10 moves in a circular motion through the vessels 20, 30, 40, 50. An example of this arrangement, where all the vessels 20, 30, 40, 50 are in direct contact with each other, is exemplified in the Figures.

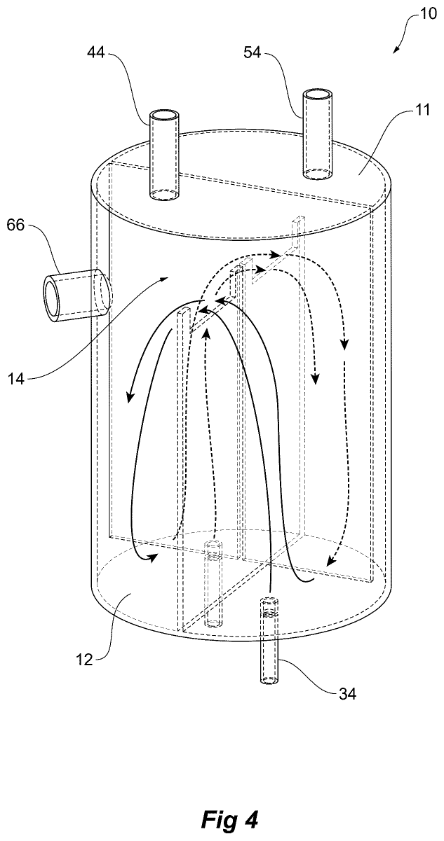

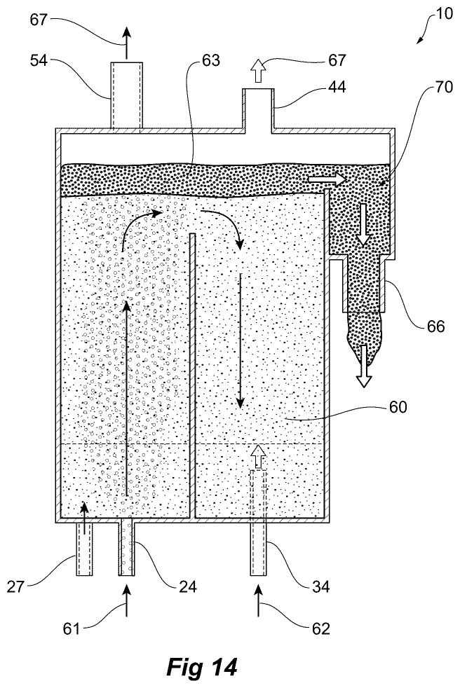

The circulation of a fluid 60 through the reactor 10 is initiated by introducing (e.g., injecting) a gas 61, 62 into the bottom of each first vessel 20, 30, through a gas inlet 24, 34, such as a nozzle (e.g., a sparger). The reactor 10 of the present invention is particularly suitable for molten substances. The fluid 60 may be selected from a molten metal, a molten salt, a molten alloy, or a combination thereof. The fluid 60 may be a molten catalyst. Examples of suitable molten catalysts include molten tin, molten gallium, and Ni_{0.27}Bi_{0.73}, and others (including molten metals, molten salts, molten alloys, and combinations thereof) are described in WO2019/226416 and WO2018/132875. The gas may be a reaction gas 61. The reaction gas 61 may be any gas that is desired to be contacted, or reacted with, the fluid 60 to produce a product 63 of interest. The reaction gas 61 may be natural gas. The reaction gas 61 may be gas derived from landfill. The reaction gas 61 may comprise methane. When the gas introduced into one of the first vessels 20 is a reaction gas 61, the gas introduced into the other first vessel 30 may be an inert gas 62. The inert gas 62 may be heated and used to provide additional heat to the fluid flowing through the vessels 20, 30, 40, 50. The gas introduced into the other first vessel 30 may be a reaction gas 61 to react with the fluid 60 (either the same as the reaction gas 61 introduced into the first vessel 20, or a different reaction gas 61), may be a gas introduced to induce lift to assist with circulation of the fluid 60 through the vessels 20, 30, 40, 50, or may be a combination of some or all of these. The movement of the gas 61 is best shown in FIGS. 4 and 14.

The vessels 20, 30, 40, 50 and the reactor 10 may be made of any material known to be suitable by a person skilled in the art for use in high temperature reactors, such as stainless steel, which may further comprise a ceramic lining for additional protection.

The gas 61, 62 is introduced into each first vessel 20, 30 under sufficient pressure to cause mixing of bubbles of the gas 61, 62 with the fluid 60, and to direct the fluid 60 to flow towards and through the aperture 28, 38 of each first vessel 20, 30 and into a connected second vessel 40, 50. The mixing of the gas 61, 62 bubbles with the fluid 60 lowers the density of the resulting fluid and gas 61, 62 mixture relative to the fluid 60 in the neighbouring second vessels 40, 50. This density difference, together with the momentum of the gas 61, 62 jet, induces a “lift” within each first vessel 20, 30, causing the mixture to rise to the top 21, 31 of each first vessel 20, 30. Most of the gas 61, 62 bubbles are separated from the fluid 60 at the top 21, 31 of each of the first vessels 20, 30, while the remaining entrained bubbles pass through the aperture 28, 38, with fluid 60 and are separated from the fluid 60 in each of the second vessels 40, 50. The fluid 60 that passes though the aperture 28, 38 of each first vessel 20, 30 moves downward, due to circulation and gravity, to the bottom of the next second vessel 40, 50. The fluid 60 then passes through the aperture at the bottom of each of the second vessels 40, 50 and to the bottom of the next first vessel 20, 30, to continue the process. In this way, a circulating wave-like motion is induced in the fluid 60 as it passes through the vessels 20, 30, 40, 50. The circulating wave-like motion can be seen in FIG. 4.

A person skilled in the art will appreciate that the gas inlet 24, 34 should be situated in each of the first vessels 20, 30 such that the fluid 60 is directed to flow towards and through the aperture 28, 38 of each first vessel 20, 30 and into a connected second vessel 40, 50. Therefore, the gas inlet 24, 34 may be present in each of the first vessels 20, 30 at the bottom of these vessels. By “at the bottom of the vessel” it is meant that the gas inlet 24, 34 is either situated in the base of the vessel 20, 40, or near the base of the vessel 20, 40, to achieve the required lifting movement of the fluid 60 by, and adequate mixing with, the heated reaction gas 61 that is introduced into each of the first vessels 20, 30 through the gas inlet 24, 34.

In the reactor 10 of the present invention, each of the first vessels 20, 30 and each of the second vessels 40, 50 comprise an aperture 28, 38, 48, 58. The aperture 28, 38 of each first vessel 20, 30 connects each first vessel 20, 30 with at least one second vessel 40, 50, the aperture 48, 58 of each second vessel 40, 50 is situated at the bottom of each second vessel 40, 50, the apertures 28, 38 of the first vessels 20, 30 are situated above the apertures 48, 58 of the second vessels 40, 50, and the apertures 28, 38, 48, 58 are arranged in a series. In this way, a circulating wave-like motion is induced in the fluid 60 as it passes through the vessels 20, 30, 40, 50, as discussed above. It will be appreciated by a person skilled in the art that the vessels 20, 30, 40, 50 referred to herein inherently possess a top and a bottom. Therefore, the vessels 20, 30, 40, 50 as referred to herein comprise a top 21, 31, 41, 51 (which may be open and therefore may be referred to as a “top portion”) and a bottom 22, 32, 42, 52. The vessels 20, 30, 40, 50 are configured to hold a fluid 60, such as a molten substance discussed herein.

At least one of the apertures 28, 38 of the first vessels 20, 30 may be situated at the top 11 of the reactor 10. It will be appreciated by a person skilled in the art that the reactor 10 referred to herein inherently possess a top and a bottom. Therefore, the reactor 10 as referred to herein comprises a top 11 and a bottom 12. By “at the top of the reactor” it is meant that the aperture 28, 38 is formed, at least in part, by the top 11 of the reactor 10, or is situated near the top 11 of the reactor 10 (e.g., near the top of a sidewall 23, 33 of the first vessel 20, 30), to achieve the required movement of the fluid 60 passing through the aperture 28, 38 i.e., allowing the fluid 60 passing up by the action of the gas 61, 62 to pass through, followed by the downward movement of the fluid 60 in the adjacent second vessel 40, 50 after the fluid has passed through the aperture 28, 38. However, it will be apparent to a person skilled in the art that the aperture 28, 38 of each of the first vessels 20, 30 may be situated at any appropriate height above the aperture 48, 58 of each of the second vessels 40, 50, provided that the movement of fluid 60 is achieved.

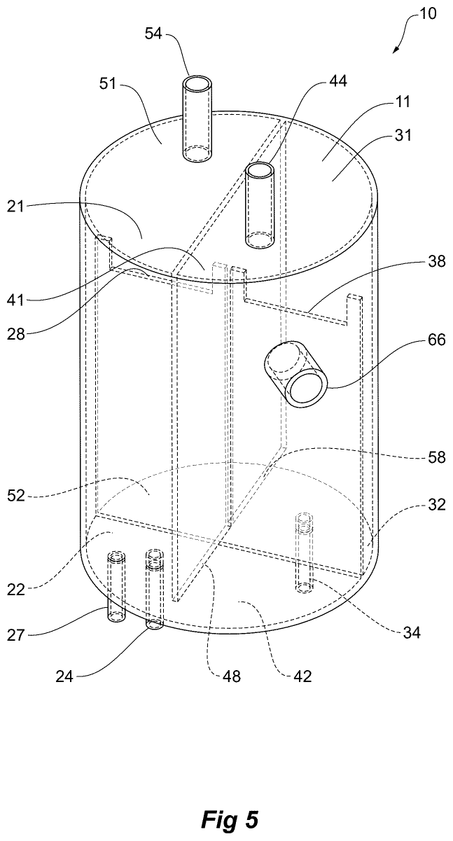

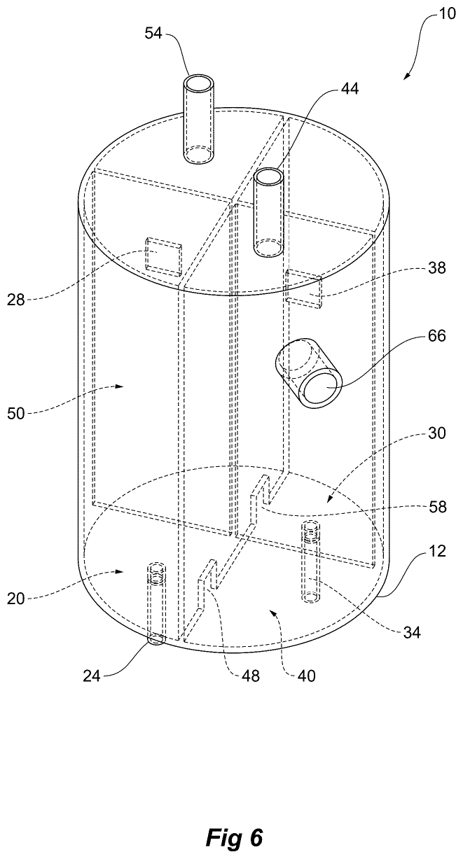

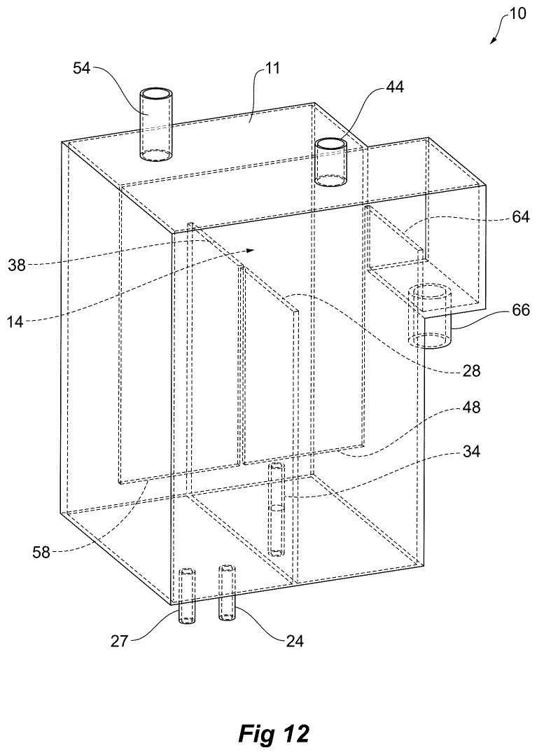

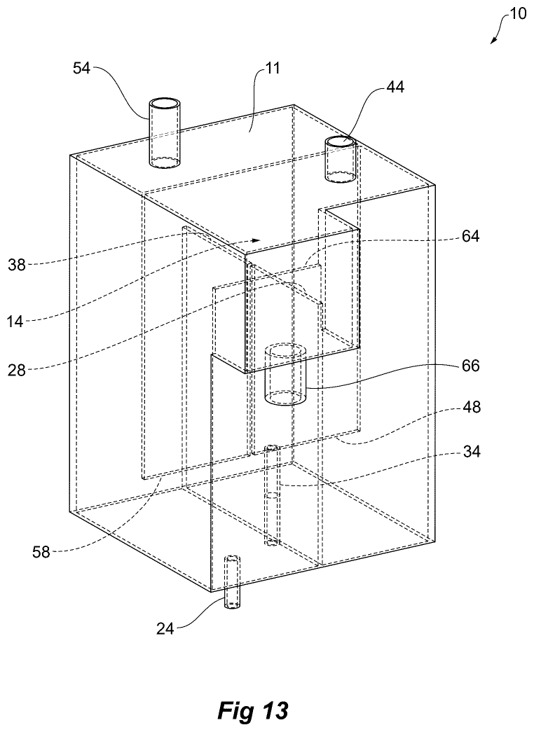

In terms of the shape and configuration of the apertures 28, 38, 48, 58, these may be any suitable shape and configuration that allows passage of the fluid 60 (or the fluid 60 and gas 61, 62 mixture) therethrough. For example, as best shown in FIGS. 1-5 and 7-14, one or more of the apertures 28, 38 of the first vessels 20, 30 may be a gap between a sidewall 23, 33 of one of the first vessels 20, 30 and the top 11 of the reactor 10, or as best shown in FIG. 6, a hole in a sidewall 23, 33 of one of the first vessels 20, 30. In embodiments in which the one or more apertures 28, 38, 48, 58 is a gap between a sidewall 23, 33 of one of the first vessels 20, 30 and the top 11 of the reactor 10, the top edge of the sidewall 23, 33 may form an overflow weir. The overflow weir may take any suitable shape. Some shapes are illustrated, such as a rectangular cutout as shown in FIG. 5, or a straight edge as shown in FIGS. 12 and 13. As best shown in FIGS. 1-5 and 7-14, at least one of the apertures 48, 58 of the second vessels 40, 50 may be a gap between a sidewall 43, 53 of one of the second vessels 40, 50 and the bottom 12 of the reactor 10 (eg an underflow weir), or as best shown in FIG. 6, a hole in a sidewall 43, 53 of one of the second vessels 40, 50. At least one of the apertures 48, 58 of the second vessels 40, 50 may be situated at the bottom 12 of the reactor 10. By “at the bottom of the reactor” it is meant that the aperture 48, 58 is formed, at least in part, by the bottom 12 of the reactor 10, or is situated near the bottom 12 of the reactor 10 (e.g., near the bottom of a sidewall 43, 53 of the second vessel 40, 50), to achieve the required movement of the fluid 60 passing through the aperture 48, 58 i.e., allowing the fluid 60 passing down through the second vessel 40, 50 by the action of gravity to pass through the aperture 48, 58 into the bottom of the next first vessel 20, 30.

The reactor 10 may further comprise at least one gas outlet 44, 54. In certain embodiments, there is one gas outlet 44. The illustrated embodiments show two gas outlets 44, 54, but the reactor 10 is not limited to two gas outlets. In certain embodiments, there are two or more gas outlets. The gas outlet 44, 54 may be situated in or at the top 11 of the reactor 10. The gas outlet 44, 54 typically serves to allow excess gases 67 (e.g., unreacted or excess heated reaction gas 61, used or excess heated inert gas 62, and/or gases produced by reactions occurring in the reactor 10) to leave the reactor 10, thereby maintaining the pressure in the reactor 10 at a desired level. By “in the top of the reactor” it is meant that gas 67 passes out of the top 11 of the reactor 10. An example of this arrangement is given in FIGS. 1-14. A person skilled in the art could readily determine the appropriate size and shape of the outlet 44, 54 to allow excess gas 67 to leave the reactor 10. In certain embodiments, the gas outlet 44, 54 may be a nozzle.

The gas outlet 44, 54 may be in communication with a headspace 14 of the reactor 10. The headspace 14 will typically be situated above the fluid 60 within the reactor 10, and may be one space, or may be divided into multiple spaces, depending on the type of reactants to be used, the purity to be achieved in the product 63, and the type of product 63 to be produced. In the embodiment where the headspace 14 is divided into multiple spaces, each space may be in communication with its own gas outlet 44, 54.

As illustrated in the Figures, at least one of the first vessels 20, 30 may further comprise at least one product outlet 66. As illustrated in FIG. 13, the product outlet 66 may be situated at the top 21, 31 of a first vessel 20, 30. Where the product 63 of the reaction between the fluid 60 and the gas 61, 62 is a solid, the solid may float to the top of the fluid 60 in the first vessel 20, 30 and be separated and removed from the vessel 20, 30 through the product outlet 66. Any remaining solid may flow into the second vessel 40, 50 through the aperture 28, 38 with the fluid 60 and may be removed through a product outlet 66 situated at the top 41, 51 of the second vessel 40, 50. Therefore, at least one of the second vessels 40, 50 may further comprise a product outlet 66. This is illustrated in FIG. 12.

The figures illustrate two embodiments in which a product outlet 66 is in either one of the first vessels 20, 30 or one of the second vessels 40, 50 (eg FIGS. 12 and 13). In certain embodiments, the reactor 10 has a product outlet 66 in one of the first vessels 20, 30 and one of the second vessels 40, 50. In other embodiments, the reactor 10 has a product outlet 66 in each of the first 20, 30 and second vessels 40, 50. In further embodiments, the reactor 10 has a product outlet 66 in each of the second vessels 40, 50 or each of the first vessels 20, 30, or any suitable combination. The person skilled in the art could readily determine the appropriate vessel 20, 30, 40, 50 for the product outlet 66, based on where the product 63 accumulates.

An embodiment of the product outlet 66 is best shown in FIG. 14, in which the product outlet 66 is illustrated at the top 41, 51 of the second vessel 40, 50. Some other embodiments are shown in FIGS. 1-13. By “at the top of the vessel” it is meant that the product outlet 66 is situated at or near the top 21, 31, 41, 51 of the vessel 20, 30, 40, 50 (e.g., near the top of a sidewall 23, 33 of the first vessel 20, 30), to allow the product 63 that has floated to the top of the fluid 60 to pass out of the vessel 20, 30 and out of the reactor 10. As best shown in FIGS. 4, 12, 13, and 14, the product outlet 66 may comprise a weir 64 configured to retain fluid 60 in the reactor 10 and allow product 63 to move over the weir 64. The product 63 may then enter the product outlet 66. The weir 64 may be in any suitable configuration. The height of the weir 64 may be at or above a level of apertures 28, 38 of the first vessels 20, 30. The relative height of the weir 64 and the apertures 28, 38 may be selected such that a level of the fluid 60 may be at or below a top edge of the weir 64, and at a level such that the fluid 60 may flow through or over the apertures 28,38. The product 63 that has floated to the top of the fluid 60 may then move over the weir 64 to the product outlet 66, while the fluid 60 is retained in the reactor 10. The product 63 may be pushed over the weir 64 by, eg, the action of further accumulating product 63. In the illustrated embodiment, the product 63 is pushed over the weir 64 and accumulates in a chamber 70 before exiting through outlet 66. The person skilled in the art could readily determine a suitable configuration of the weir 64, chamber 70 and outlet 66, eg, the chamber 70 could be absent such that the product 63 is pushed over the weir 64 and exits through outlet 66. Alternatively, the sidewall 23, 33, 43, 53 of the vessel 20, 30, 40, 50 could perform the function of the weir 64, such that the product 63 is pushed through outlet 66, eg, as shown in FIGS. 5 and 6. In other embodiments, the chamber 70 could be enlarged to temporarily store the product 63 before it is removed from the chamber 70.

The weir 64 may be in any suitable position to retain fluid 60 in the reactor 10. In the illustrated embodiment of FIG. 14, the weir 64 is formed by a sidewall 43, 53 of a second vessel 40, 50. In other embodiments, the weir 64 is positioned on or near an outer sidewall 23, 33 of a first or second vessel 20, 30. The weir 64 may be aligned with a sidewall 23, 33, 43, 55 of any of the first or second vessels 20, 30, 40, 50. In FIG. 12, the weir 64 is parallel to the sidewall 23 of the first vessel comprising the aperture 28 in the form of an overflow weir 64. In FIG. 13, the weir 64 is parallel to the sidewall 43 of the second vessel comprising the aperture 48 in the form of an underflow weir 64. The angle of the weir 64 may be determined by the person skilled in the art to take advantage of the movement of the fluid 60 to push the product 63 over the weir 64.

As shown in FIGS. 5, 12 and 14, at least one of the first vessels 20, 30 may further comprise a feed stream inlet 27. The feed stream inlet 27 may be situated at the bottom 22, 32 of the first vessel 20, 30. The feed stream inlet 27 may function to introduce a fluid 60 into the first vessel 20, 30. At least one of the second vessels 40, 50 may further comprise a feed stream inlet (not shown). The feed stream inlet may be situated at the bottom 42, 52 of the second vessel 40, 50. By “at the bottom of the vessel” it is meant that the feed stream inlet 27 is either situated in the base of the vessel 20, 30, 40, 50, or near the base of the vessel 20, 30, 40, 50, to allow introduction of the fluid 60 into the vessel 20, 30, 40, 50.

The present invention also relates to a method of reacting a fluid with a gas to produce a solid product, the method comprising:
providing a reactor as described herein, wherein the reactor comprises, in a first vessel (vessel A), a fluid;
introducing into vessel A a reaction gas for mixing and reaction with the fluid, such that the gas passes through the fluid and directs the fluid and gas mixture to flow towards and through the aperture of vessel A and into a connected second vessel (vessel B), wherein the aperture of vessel B allows the fluid flowing through vessel B from vessel A to flow into a further first vessel (vessel C);
introducing into vessel C a second gas, the second gas directing the fluid and gas mixture to flow towards and through the aperture of vessel C and into a connected second vessel (vessel D), wherein the aperture of vessel D allows the fluid flowing through vessel D from vessel C to flow back into vessel A;
collecting a solid product from the product outlet.

The fluid may be selected from a molten metal, a molten salt, a molten alloy, or a combination thereof. The fluid may be a molten catalyst. Examples of suitable molten catalysts include molten tin, molten gallium, and Ni_{0.27}Bi_{0.73}, and others (including molten metals, molten salts, molten alloys, and combinations thereof) are described in WO2019/226416 and WO2018/132875.

The reaction gas may be any gas that is desired to be contacted, or reacted with, the fluid to produce a product of interest. The reaction gas may be natural gas. The reaction gas may comprise methane. The reaction gas may consist of methane. The reaction gas may be a combination of a hydrocarbon with steam or CO₂ for dry or wet gasification.

The solid product may be carbon. Accordingly, the reaction may be the pyrolysis of methane (CH₄→2H₂+C) or pyrolysis of any other gases or hydrocarbons.

When the gas introduced into one of the first vessels is a reaction gas, the second gas may be an inert gas. The inert gas may be heated and used to provide additional heat to the fluid flowing through the vessels. The second gas may be a reaction gas (either the same as the reaction gas introduced into the first vessel, or a different reaction gas) to react with the fluid, may be a gas introduced to induce lift to assist with circulation of the fluid through the vessels, or may be a combination of some or all of these.

Reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

### EXAMPLE

One potential application of the reactor is for methane pyrolysis using a molten catalyst, such as molten tin, molten gallium, or Ni_{0.27}Bi_{0.73}. Therefore, the fluid circulating between the vessels is a molten catalyst. Methane is introduced into one of the first vessels through a gas inlet and is converted to hydrogen and carbon as it moves up through the fluid and the vessel. This also induces an upward movement of the fluid within the vessel, which causes the molten catalyst to circulate through the vessels within the reactor. The heat required for methane pyrolysis, as an endothermic reaction, can be supplied through heating of the molten catalyst through the reactor and/or vessel walls, via injection of a high temperature inert gas into the other first vessel, and/or by heating the vessel walls using electrical resistive heating. The inert gas also induces upward lift and further accelerates the circulation of the fluid through the vessels. The product (solid carbon) floats to the surface of the first vessel (where the methane is injected), from where it can be removed. Solid carbon might be also transferred to the adjacent second vessel along with the fluid, form where the solid carbon can also be removed.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A reactor for reacting a fluid with a gas, the reactor comprising:
two first vessels, each first vessel comprising a gas inlet; and
two second vessels,
wherein one of the second vessels is situated between the two first vessels such that the said one of the second vessels is in direct contact with each first vessel, and at least one of the first vessels is situated between the two second vessels such that the said at least one of the first vessels is in direct contact with each of the two second vessels, wherein the direct contact facilitates heat exchange between the vessels, and
wherein each of the first vessels and each of the second vessels comprise an aperture, wherein:
the aperture of each first vessel connects each first vessel with at least one second vessel,
the aperture of each second vessel is situated at the bottom of each second vessel,
the apertures of the first vessels are situated above the apertures of the second vessels, and
the apertures are arranged in a series,
such that fluid in the first vessels is directed to flow towards and through the aperture of each first vessel and into a connected second vessel by gas entering each first vessel through the gas inlet, and the apertures of the second vessels allow the fluid flowing from each first vessel and through each second vessel to flow into a first vessel connected to the second vessel.

2. The reactor as claimed in claim 1, wherein at least one of the apertures of the first vessels is situated at the top of the reactor.

3. The reactor as claimed in claim 1, wherein at least one of the apertures of the first vessels is a gap between a sidewall of one of the first vessels and the top of the reactor, or at least one of the apertures of the first vessels is a hole in a sidewall of one of the first vessels.

4. (canceled)

5. The reactor as claimed in claim 1, wherein at least one of the apertures of the second vessels is situated at the bottom of the reactor.

6. The reactor as claimed in claim 1, wherein at least one of the apertures of the second vessels is a gap between a sidewall of one of the second vessels and the bottom of the reactor, or wherein at least one of the apertures of the second vessels is a hole in a sidewall of one of the second vessels.

7. (canceled)

8. The reactor as claimed in claim 1, wherein, in at least one of the first vessels, the gas inlet is situated at the bottom of the vessel.

9. The reactor as claimed in claim 1, wherein each of the first vessels is situated between, is in direct contact with, and is connected to two second vessels, such that fluid flowing through the reactor moves in a circular motion through the vessels.

10. The reactor as claimed in claim 1, further comprising at least one gas outlet.

11. The reactor as claimed in claim 10, wherein the gas outlet is situated in or at the top of the reactor.

12. The reactor as claimed in claim 1, wherein at least one of the first vessels further comprises at least one product outlet.

13. The reactor as claimed in claim 12, wherein the product outlet is situated at the top of the first vessel.

14. The reactor as claimed in claim 12, wherein a weir is configured to retain fluid in the reactor and allow product to enter the product outlet of the first vessel.

15. The reactor as claimed in any claim 1, wherein at least one of the second vessels further comprises at least one product outlet.

16. The reactor as claimed in claim 15, wherein the product outlet is situated at the top of the second vessel.

17. The reactor as claimed in claim 15, wherein a weir is configured to retain fluid in the reactor and allow product to enter the product outlet of the second vessel.

18. A method of reacting a fluid with a gas to produce a solid product, the method comprising:
providing a reactor as claimed in claim 1, wherein the reactor contains, in a first vessel (vessel A), a fluid;
introducing into vessel A a reaction gas for mixing and reaction with the fluid, such that the gas passes through the fluid and directs the fluid and gas mixture to flow towards and through the aperture of vessel A and into a connected second vessel (vessel B), wherein the aperture of vessel B allows the fluid flowing through vessel B from vessel A to flow into a further first vessel (vessel C);
introducing into vessel C a second gas, the second gas directing the fluid and gas mixture to flow towards and through the aperture of vessel C and into a connected second vessel (vessel D), wherein the aperture of vessel D allows the fluid flowing through vessel D from vessel C to flow back into vessel A; and
collecting a solid product from the product outlet.

19. The method as claimed in claim 18, wherein the fluid is selected from a molten metal, a molten salt, a molten alloy, or a combination thereof.

20. The method as claimed in claim 19, wherein the fluid is a molten catalyst.

21. The method as claimed in claim 18, wherein the reaction gas is natural gas, and the solid product is carbon.

22. (canceled)

23. (canceled)

24. The method as claimed in claim 18, wherein the second gas is an inert gas.
